(19) United States
(12) Patent Application Publication
(10) Pub. No.: US 2025/0071192 A1
(43) Pub. Date: Feb. 27, 2025

(54) RELAY DEVICE, RELAY METHOD, AND RECORDING MEDIUM

(71) Applicant: Mitsubishi Electric Corporation, Tokyo (JP)

(72) Inventors: Kentaro SAWA, Tokyo (JP); Satoshi HANAI, Tokyo (JP); Takamitsu YAMADA, Tokyo (JP)

(21) Appl. No.: 18/721,422

(22) PCT Filed: Jan. 6, 2022
(86) PCT No.: PCT/JP2022/000229

§ 371 Date: Jun. 18, 2024

(51) Int. Cl. H04L 69/08

(52) U.S. Cl. CPC H04L 69/08

(57) ABSTRACT

A relay device includes a conversion table storage to store a first conversion table in which a property of a first data model corresponding to a first protocol is associated with its higher-order property and a second conversion table in which a property of a second data model corresponding to a second protocol is associated with its higher-order property. When a communication frame from a first device whose communication protocol is the first protocol is received, the relay device converts property included in the communication frame into its higher-order property with reference to the first conversion table and converts the higher-order property into a property of the second data model with reference to the second conversion table. The relay device generates a communication frame conforming to the second protocol and including the property of the second data model and transmits the generated communication frame to a second device.

### TECHNICAL FIELD

The disclosure relates to a relay device, a relay method, and a program.

### BACKGROUND ART

Various technologies for relaying communication between devices that perform communication using different communication protocols from each other have been proposed.

For example, Patent Literature 1 discloses a communication system including a main system that is a higher-order system, subsystems that are lower-order systems, and interfaces that are connected to the subsystems in one-to-one correspondence, in which each interface converts a protocol of a signal when relaying the signal between the corresponding subsystem and a transmission line.

Specifically, in this communication system, each interface converts the signal received from the corresponding subsystem into a primary signal of a standard protocol and transmits the resulting primary signal to the transmission line. Each interface also converts the primary signal received from the transmission line into a secondary signal of the protocol of the corresponding subsystem and outputs the resulting secondary signal to the corresponding subsystem. This enables the communication system disclosed in Patent Literature 1 to achieve coordination among the subsystems even when the subsystems use different protocols.

### CITATION LIST

### Patent Literature

Patent Literature 1: Unexamined Japanese Patent Application Publication No. 2019-83458

### SUMMARY OF INVENTION

### Technical Problem

Interactions between devices of different manufactures using the same data model by determining standard specifications for data models, which are application-level formats for communication between devices, are known to be available in recent years.

Even if the communication protocols are different, equivalent conversion of communication protocols can be achieved relatively easily because, in most cases, the communication protocols generally differ only in message format and have shared basic content, such a source address and a destination address.

However, equivalent conversion for different data models is difficult to achieve because the data models have properties with different predefined granularities. Thus, there are circumstances where proposals for a new technique of relaying communication between devices having different data models from each other are desired.

The present disclosure is made in view of the above circumstances, and an objective of the present disclosure is to provide a relay device, a relay method, and a program that enable relaying communication between devices having different data models from each other.

### Solution to Problem

To achieve the above objective, a relay device according to the present disclosure includes:
first communication means for communicating with a first device whose communication protocol is a first protocol;
second communication means for communicating with a second device whose communication protocol is a second protocol that is different from the first protocol;
conversion table storage means for storing a first conversion table for a first data model corresponding to the first protocol and a second conversion table for a second data model corresponding to the second protocol, the first conversion table being a table in which a property of the first data model is associated with a higher-order property of the property of the first data model, the second conversion table being a table in which a property of the second data model is associated with a higher-order property of the property of the second data model;
data model conversion means for
   when a communication frame from the first device is received, converting a property included in the communication frame into a higher-order property with reference to the first conversion table, and converting the higher-order property into a property of the second data model with reference to the second conversion table, and
   when a communication frame from the second device is received, converting a property included in the communication frame into a higher-order property with reference to the second conversion table, and converting the higher property into a property of the first data model with reference to the first conversion table; and
communication frame transmission means for
   generating a communication frame conforming to the second protocol and including the property of the second data model obtained by the data model conversion means, and transmitting the generated communication frame to the second device, and
   generating a communication frame conforming to the first protocol and including the property of the first data model obtained by the data model conversion means, and transmitting the generated communication frame to the first device.

### Advantageous Effects of Invention

The present disclosure enables relaying communication between devices having different data models from each other.

### BRIEF DESCRIPTION OF DRAWINGS

FIG. 1 is a diagram illustrating an overall configuration of a network system including a relay device in Embodiment 1;

FIG. 2 is a block diagram illustrating a hardware configuration of the relay device in Embodiment 1;

FIG. 3 is a block diagram illustrating a hardware configuration of a first device in Embodiment 1;

FIG. 4 is a block diagram illustrating a hardware configuration of a second device in Embodiment 1;

FIG. 5 is a block diagram illustrating a functional configuration of the relay device in Embodiment 1;

FIG. 6 is a diagram illustrating a sequence at initial connection of the relay device with the first device and the second device in Embodiment 1;

FIGS. 7A and 7B are diagrams illustrating examples of conversion tables in Embodiment 1, in which FIG. 7A illustrates the conversion table corresponding to the first device and FIG. 7B illustrates the conversion table corresponding to the second device;

FIG. 8 is a schematic diagram of relay of communication frames from the first device to the second device in Embodiment 1;

FIG. 9 is a schematic diagram of relay of communication frames from the second device to the first device in Embodiment 1;

FIG. 10 is a flowchart illustrating a procedure for relay processing in Embodiment 1 (Part 1);

FIG. 11 is a flowchart illustrating a procedure for relay processing in Embodiment 1 (Part 2);

FIGS. 12A and 12B are diagrams illustrating examples of conversion tables in a modified example of Embodiment 1, in which FIG. 12A illustrates a conversion table corresponding to the first device and FIG. 12B illustrates a conversion table corresponding to the second device;

FIG. 13 is a diagram illustrating an overall configuration of a network system including a relay device in Embodiment 2;

FIG. 14 is a block diagram illustrating a functional configuration of the relay device in Embodiment 2;

FIG. 15 is a diagram illustrating a sequence at initial connection of the relay device with the first device and the second device in Embodiment 2; and

FIG. 16 is a flowchart illustrating a procedure for conversion table obtainment processing in Embodiment 2.

### DESCRIPTION OF EMBODIMENTS

Embodiments of the present disclosure are described hereinafter in detail with reference to the drawings.

### Embodiment 1

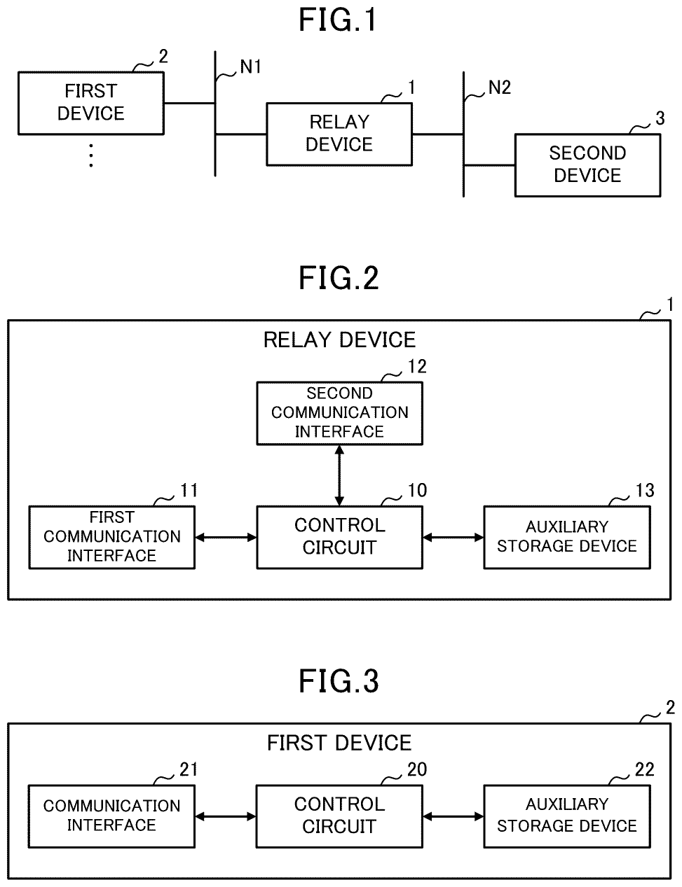

FIG. 1 is a diagram illustrating an overall configuration of a network system including a relay device 1 in Embodiment 1. In this network system, one or more first devices 2 and the relay device 1 are connected to a network N1, and the relay device 1 and a second device 3 are connected to a network N2. This network system is applied, for example, to a system for controlling home appliances in a house.

### Relay Device 1

The relay device 1 is an example of a relay device according to the present disclosure and relays communication between devices that perform communication using different communication protocols from each other. As illustrated in FIG. 2, the relay device 1 includes, as a hardware configuration, a control circuit 10, a first communication interface 11, a second communication interface 12, and an auxiliary storage device 13. The control circuit 10 conducts overall control of the relay device 1. The control circuit 10 includes a central processing unit (CPU), a read only memory (ROM), and a random access memory (RAM), none of which are illustrated. Details of functions of the relay device 1 achieved by the control circuit 10 are described later.

The first communication interface 11 is an example of first communication means according to the present disclosure. The first communication interface 11 is an interface for communicating with each first device 2 via the network N1. The second communication interface 12 is an example of second communication means according to the present disclosure. The second communication interface 12 is an interface for communicating with the second device 3 via the network N2.

The auxiliary storage device 13 is a storage device including a readable and writable non-volatile semiconductor memory, a hard disk drive (HDD), and the like. The readable and writable non-volatile semiconductor memory is, for example, an electrically erasable programmable read-only memory (EEPROM), a flash memory, or the like. The auxiliary storage device 13 stores various types of programs including a program (hereinafter referred to as a “relay program”) for relaying communication frames received and sent between the first device 2 and the second device 3, and data for use in execution of these programs.

The relay device 1 can, by communication via the networks N1 and N2 or the other networks, obtain from other devices the above relay program or an update program for updating the relay program. Also, these programs can be stored and distributed in a computer-readable recording medium, such as a compact disc read only memory (CD-ROM), a digital versatile disc (DVD), a magneto-optical disc, a universal serial bus (USB) memory, an HDD, a solid state drive (SSD), a memory card, or the like. With such a recording medium attached to the relay device 1 directly or indirectly, the relay device 1 may read and obtain the relay program or the update program from the recording medium.

### First Device 2

The first device 2 is an example of a first device according to the present disclosure. The first device 2 is a device that performs communication using a communication protocol A. Examples of the first device 2 include an air-conditioning device, a lighting device, and various types of sensors. The communication protocol A is an example of a first protocol according to the present disclosure, for example, Zigbee (registered trademark). The first device 2 performs communication using a data model A as a data model that is an application-level format. The data model A is an example of a first data model according to the present disclosure.

As illustrated in FIG. 3, the first device 2 includes as a hardware configuration a control circuit 20, a communication interface 21, and an auxiliary storage device 22. The first device 2 further includes hardware to achieve intrinsic functions of the first device 2 (e.g., functions for air conditioning in the case of an air-conditioning device, functions for lighting in the case of a lighting device, etc.).

The control circuit 20 includes a CPU, a ROM, and a RAM, none of which are illustrated, and conducts overall control of the first device 2. The communication interface 21 is an interface for communicating with other devices, such as the relay device 1 and another first device 2, via a network N1. As described above, the first device 2 communicates with the other devices using the communication protocol A.

The auxiliary storage device 22 is configured to include a readable and writable non-volatile semiconductor memory, such as an EEPROM, a flash memory, or the like. The auxiliary storage device 22 stores a program relating to control of the first device 2 and data for use in execution of the program.

### Second Device 3

The second device 3 is an example of a second device according to the present disclosure. The second device 3 is a device that performs communication using a communication protocol B. The second device is, for example, a controller that performs centralized control over each first device 2. The communication protocol B is an example of a second protocol according to the present disclosure, for example, ECHONET Lite (registered trademark). The second device 3 performs communication using a data model B as a data model. The data model B is an example of a second data model according to the present disclosure.

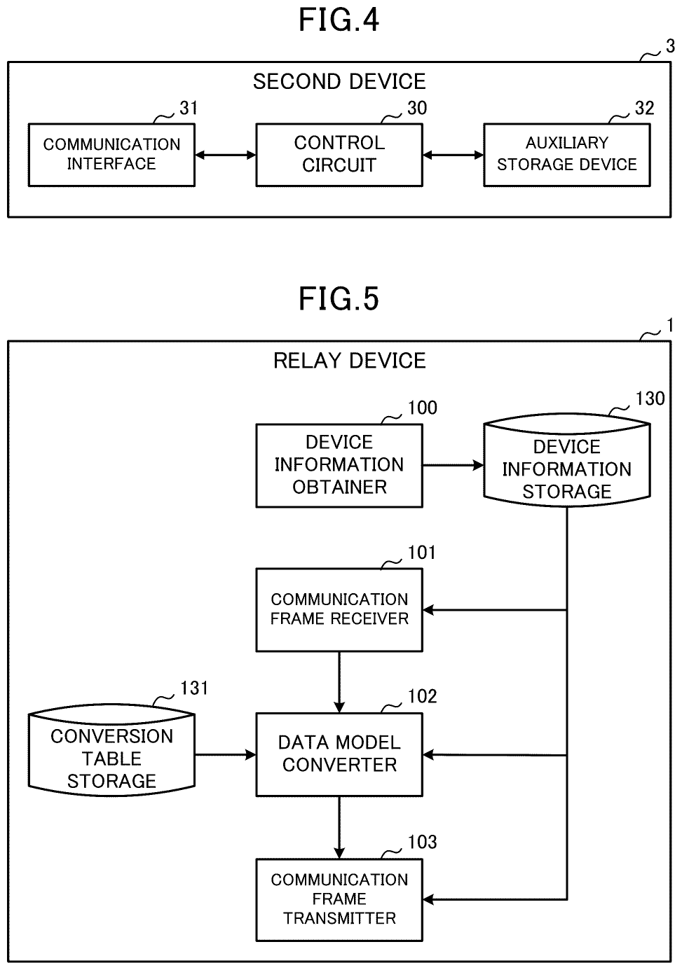

As illustrated in FIG. 4, the second device 3 includes, as a hardware configuration, a control circuit 30, a communication interface 31, and an auxiliary storage device 32. The control circuit 30 includes a CPU, a ROM, and a RAM, none of which are illustrated, and conducts overall control of the second device 3. The communication interface 31 is an interface for communicating with the relay device 1 via the network N2. As described above, the second device 3 communicates with the other devices using the communication protocol B. The auxiliary storage device 32 includes a readable and writable non-volatile semiconductor memory, such as an EEPROM, a flash memory, or the like. The auxiliary storage device 32 stores a program relating to control of the second device 3 and data for use in execution of the program.

### Functional Configuration of Relay Device 1

FIG. 5 is a block diagram illustrating a functional configuration of the relay device 1. As illustrated in FIG. 5, the relay device 1 includes a device information obtainer 100, a communication frame receiver 101, a data model converter 102, and a communication frame transmitter 103. These functional components are achieved by the control circuit 10 executing the above-described relay program stored in the auxiliary storage device 13.

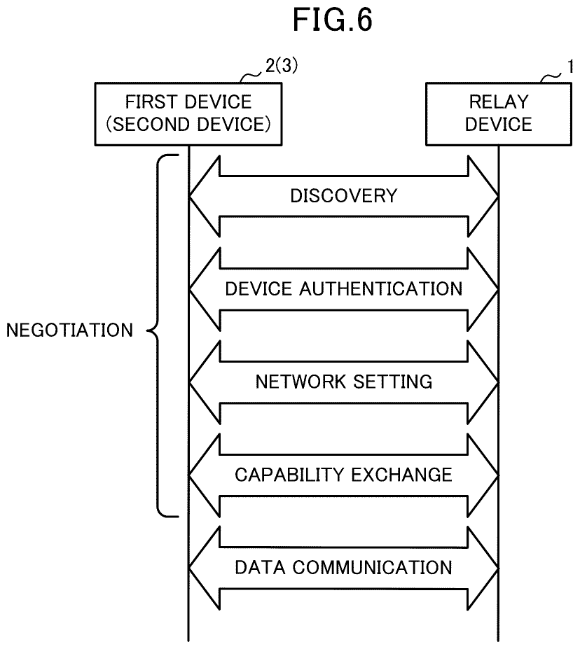

The device information obtainer 100 obtains, from the connected devices (the first device 2 and the second device 3), the device information for the connected devices. The device information includes communication information and property information. Specifically, as illustrated in FIG. 6, the device information obtainer 100 obtains, by network setting in negotiation at the initial connection with a device, the communication information, such as communication speed, from the device, and obtains the property information from the device by capability exchange in the negotiation. The property information is described later.

The device information obtainer 100 saves the obtained device information of each first device 2 and the obtained device information of the second device 3 in a device information storage 130 separately for each device. The device information storage 130 is a memory area provided by the auxiliary storage device 13.

The communication frame receiver 101 receives, via the network N1, a communication frame transmitted from the first device 2, i.e., a communication frame conforming to the communication protocol A, and receives, via the network N2, a communication frame transmitted from the second device 3, i.e., a communication frame conforming to the communication protocol B. Hereinafter, the communication frame from the first device 2 received by the communication frame receiver 101 is referred to as a communication frame A1, and the communication frame from the second device 3 received by the communication frame receiver 101 is referred to as a communication frame B1.

The data model converter 102 is an example of data model conversion means according to the present disclosure. The data model converter 102 converts a property included in the communication frame received by the communication frame receiver 101 into a property of a data model corresponding to the communication protocol of the destination device. Specifically, when the communication frame A1 is received by the communication frame receiver 101, the data model converter 102 converts the property of the data model A included in the communication frame A1 into the property of the data model B. When the communication frame B1 is received by the communication frame receiver 101, the data model converter 102 converts the property of the data model B included in the communication frame B1 into the property of the data model A.

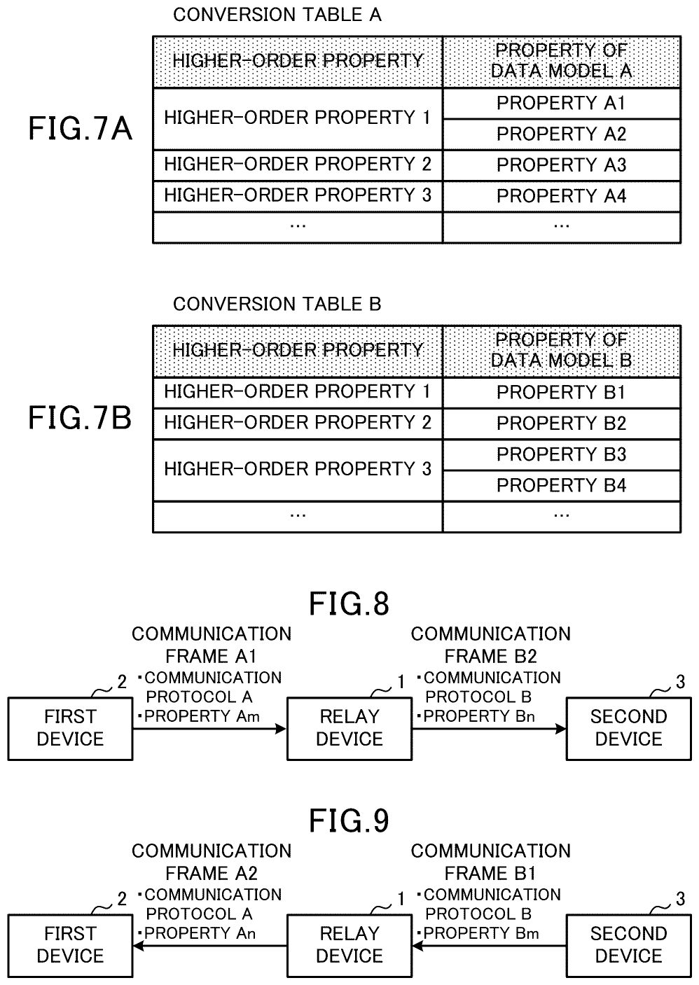

The data model converter 102 refers to the conversion table stored in the conversion table storage 131 in the above conversion. The conversion table storage 131 is an example of conversion table storage means according to the present disclosure and is a memory area provided by the auxiliary storage device 13. In the present embodiment, the conversion table storage 131 stores the conversion table A illustrated in FIG. 7A and the conversion table B illustrated in FIG. 7B.

The conversion table A is an example of a first conversion table according to the present disclosure, and is a conversion table for the data model A corresponding to the communication protocol A, which is the communication protocol of the first device 2. The conversion table B is an example of a second conversion table according to the present disclosure, and is a conversion table for the data model B corresponding to the communication protocol B, which is the communication protocol of the second device 3. As illustrated in FIG. 7A, the conversion table A is a data table in which the properties of the data model A (properties A1, A2, . . . ) are associated with their higher-order properties. In the conversion table A, each property A is associated with any one of the higher-order properties.

The conversion table B is a data table in which the properties of the data model B (properties B1, B2, . . . ) are associated with their higher-order properties. In the conversion table B, each property B is associated with any one of the higher-order properties. In the present embodiment, the higher-order properties of the data model A and the higher-order properties of the data model B share a common format. That is, the conversion table A and the conversion table B have the higher-order properties 1, 2, . . . in common.

For example, in the conversion table A, the property A1 indicates “color temperature setting,” the property A2 indicates “hue setting,” and the higher-order property 1 indicates “lighting color change”. In the conversion table B, the higher-order property 1 indicates “lighting color change” and the property B1 indicates “selection of color pattern (white light/electric light/ . . . )”.

The conversion tables corresponding to different communication protocols, including conversion tables A and B, may be stored in the conversion table storage 131 before shipment of the relay device 1, or may be stored in the conversion table storage 131 at the time of installation or after installation of the relay device 1 by a person in charge of installation, maintenance, or the like.

### Example 1 of Data Model Conversion

The following is a specific description of data model conversion in a case where the communication frame A1 from the first device 2 is received by the communication frame receiver 101, the property of the data model A included in the communication frame A1 is the property A1, and a relay destination device is the second device 3.

First, the data model converter 102 obtains from the conversion table storage 131 the conversion table A, which is a conversion table corresponding to the communication protocol A that is a communication protocol of the first device 2, and also obtains from the conversion table storage 131 the conversion table B, which is a conversion table corresponding to the communication protocol B, that is a communication protocol of the second device 3. Next, the data model converter 102 refers to the conversion table A and converts the property A1 into its higher-order property 1.

The data model converter 102 then refers to the conversion table B and converts the higher-order property 1 into the property B1 that is a property of the data model B corresponding to the higher-order property 1. In this way, the property A1, which is a property of the data model A, is converted into the property B1 that is a property of the data model B, and then the data model conversion in this example is complete.

### Example 2 of Data Model Conversion

The following is a specific description of data model conversion in a case where the communication frame B1 from the second device 3 is received by the communication frame receiver 101, the property of the data model B included in communication frame B1 is the property B4, and the relay destination device is the first device 2.

First, the data model converter 102 obtains from the conversion table storage 131 the conversion table B, which is a conversion table corresponding to the communication protocol B that is a communication protocol of the second device 3, and also obtains from the conversion table storage 131 the conversion table A, which is a conversion table corresponding to the communication protocol A that is a communication protocol of the first device 2. Next, the data model converter 102 refers to the conversion table B and converts the property B4 into its higher-order property 3.

The data model converter 102 then refers to the conversion table A and converts the higher-order property 3 into the property A4, which is a property of the data model A corresponding to the higher-order property 3. In this way, the property B4, which is a property of the data model B, is converted into the property A4, which is a property of the data model A, and then the data model conversion in this example is complete.

### Example 3 of Data Model Conversion

The following is specific explanation of data model conversion in a case where the communication frame A1 from the first device 2 is received by the communication frame receiver 101, the property of the data model A included in the communication frame A1 is the property A4, and the relay destination device is the second device 3.

First, the data model converter 102 obtains from the conversion table storage 131 the conversion table A, which is a conversion table corresponding to the communication protocol A that is a communication protocol of the first device 2, and also obtains from the conversion table storage 131 the conversion table B, which is a conversion table corresponding to the communication protocol B that is a communication protocol of the second device 3. Next, the data model converter 102 refers to the conversion table A and converts the property A4 into its higher-order property 3.

The data model converter 102 then refers to the conversion table B and converts the higher-order property 3 into a property of the data model B corresponding to the higher-order property 3. Here, the high-order property 3 in the conversion table B has two properties, the property B3 and the property B4. In this case, the data model converter 102 obtains the device information corresponding to the second device 3 from the device information storage 130, and refers to the property information included in the obtained device information and converts the higher-order property 3 into any one of the properties B3 and B4.

Among the properties included in the conversion table (in this case, the conversion table B) corresponding to the communication protocol (in this case, the communication protocol B) of the device (in this case, the second device 3), the property information includes information on a property not supported by the device. For example, in a case where the second device 3 does not support the property B4, the data model converter 102 converts the higher-order property 3 into the property B3. In this way, the property A4, which is a property of the data model A, is converted into the property B3, which is a property of the data model B, and the data model conversion in this example is complete.

Referring back to FIG. 5, the communication frame transmitter 103 is an example of communication frame transmission means according to the present disclosure. The communication frame transmitter 103 generates a communication frame conforming to the communication protocol of the relay destination device and including a property obtained by the data model converter 102, and transmits the generated communication frame to the relay destination device. For example, in a case where the relay destination of the communication frame A1 received from the first device 2 via the first communication interface 11 and including a property Am (m is a natural number equal to or greater than 1) is the second device 3, the communication frame transmitter 103 generates a communication frame conforming to the communication protocol B and including a property Bn (n is a natural number equal to or greater than 1), and transmits the generated communication frame (hereinafter referred to as a “communication frame B2”) to the second device 3 via the second communication interface 12 (see FIG. 8).

In a case where the relay destination of the communication frame B1 received from the second device 3 via the second communication interface 12 and including a property Bm is the first device 2, the communication frame transmitter 103 generates a communication frame conforming to the communication protocol A and including a property An, and transmits the generated communication frame (hereinafter referred to as a “communication frame A2”) to the first device 2 via the first communication interface 11 (see FIG. 9).

### Relay Processing

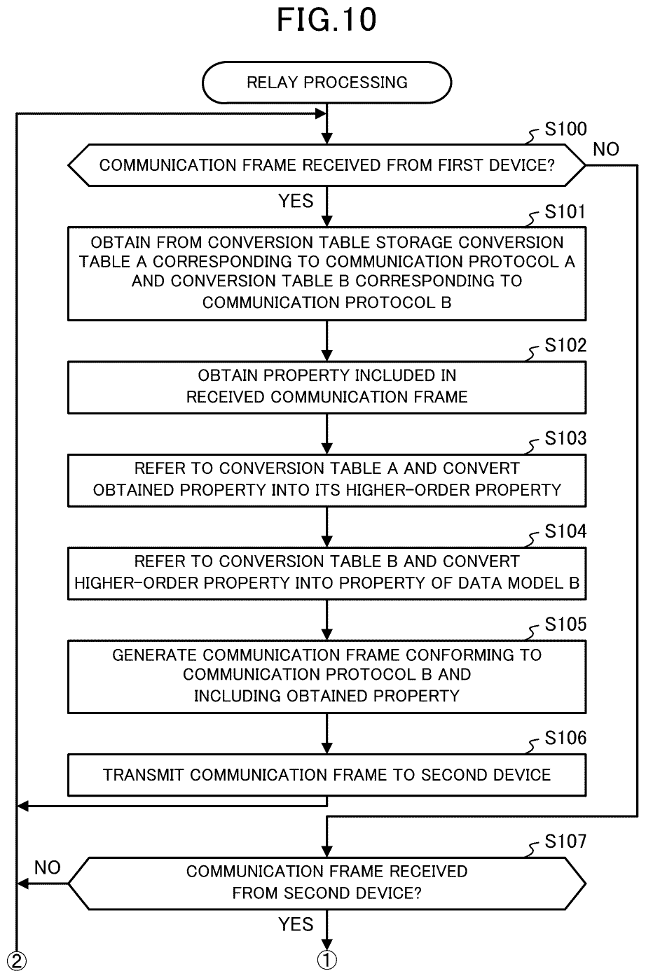

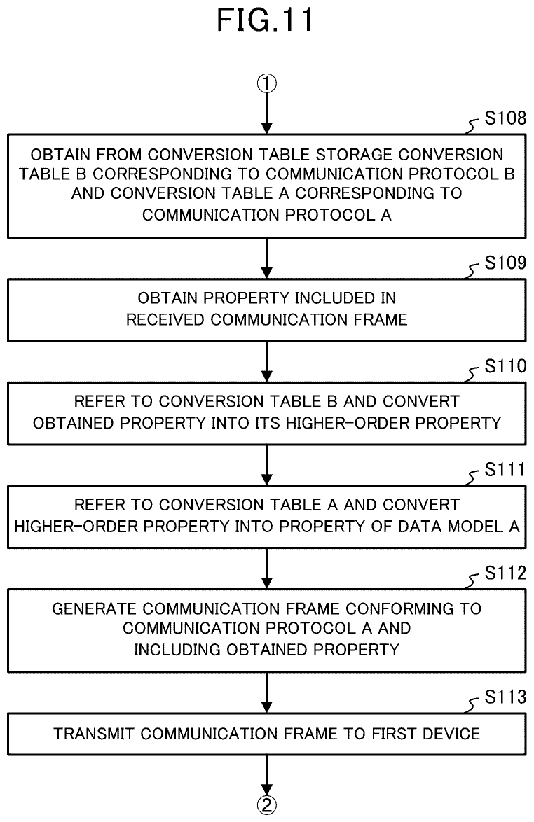

FIGS. 10 and 11 are flowcharts illustrating procedures for relay processing executed by the relay device 1.

### Step S100

The relay device 1 determines whether or not the relay device 1 receives a communication frame (i.e., the communication frame A1) from the first device 2. When the communication frame A1 is received (Yes in step S100), the processing by the relay device 1 moves to step S101. When the communication frame A1 is not received (No in step S100), the processing by the relay device 1 moves to step S107.

### Step S101

The relay device 1 obtains from the conversion table storage 131 the conversion table A corresponding to the communication protocol A, which is a communication protocol of the first device 2, and the conversion table B corresponding to communication protocol B, which is a communication protocol of the second device 3. The processing by the relay device 1 then moves to step S102.

### Step S102

The relay device 1 obtains the property included in the received communication frame A1. The processing by the relay device 1 then moves to step S103.

### Step S103

The relay device 1 refers to the conversion table A and converts the obtained property into its higher-order property. The processing by the relay device 1 then moves to step S104.

### Step S104

The relay device 1 refers to the conversion table B and converts the obtained higher-order property into the property of the data model B. In a case where there are multiple corresponding properties for such higher-order property in the conversion table B, the relay device 1 selects one property by referring to the property information of the device information of the second device 3, and converts the higher-order property into the selected property. The processing by the relay device 1 then moves to step S105.

### Step S105

The relay device 1 generates a communication frame (i.e., the communication frame B2) conforming to the communication protocol B and including the property obtained in step S104. The processing by the relay device 1 then moves to step S106.

### Step S106

The relay device 1 transmits the generated communication frame B2 to the second device 3 via the network N2. The processing by the relay device 1 then returns to step S100.

### Step S107

The relay device 1 determines whether or not the relay device 1 receives a communication frame (i.e., the communication frame B1) from the second device 3. When the communication frame B1 is received (Yes in step S107), the processing by relay device 1 moves to step S108 in FIG. 11. When the communication frame B1 is not received (No in step S107), the processing by the relay device 1 returns to step S100.

### Step S108

The relay device 1 obtains from the conversion table storage 131 the conversion table B corresponding to the communication protocol B, which is a communication protocol of the second device 3, and the conversion table A corresponding to the communication protocol A, which is a communication protocol of the first device 2. The processing by the relay device 1 then moves to step S109.

### Step S109

The relay device 1 obtains the property included in the received communication frame B1. The processing by the relay device 1 then moves to step S110.

### Step S110

The relay device 1 refers to the conversion table B and converts the obtained property into its higher-order property. The processing by the relay device 1 then moves to step S111.

### Step S111

The relay device 1 refers to the conversion table A and converts the obtained high-level property into a property of the data model A. In a case where there are multiple corresponding properties in its higher-order property in the conversion table A, the relay device 1 selects one property by referring to the property information in the device information of the first device 2, and converts the high-level property into the selected property. The processing by the relay device 1 then moves to step S112.

### Step S112

The relay device 1 generates a communication frame (i.e., the communication frame A2) conforming to the communication protocol A and including the property obtained in step S111. The processing by the relay device 1 then moves to step S113.

### Step S113

The relay device 1 transmits the generated communication frame A2 to the first device 2 via network N1. The processing by the relay device 1 then returns to step S100 in FIG. 10.

As described above, in a case where the relay device 1 of the present embodiment receives, for example, from the first device 2 that performs communication using the communication protocol A, a communication frame addressed to the second device 3 that performs communication using the communication protocol B, the relay device 1 refers to the conversion table A corresponding to the communication protocol A and converts the property included in the communication frame into its higher-order property, and refers to the conversion table B corresponding to the communication protocol B and converts the higher-order property into a property of the data model B. Then, the relay device 1 generates a communication frame conforming to the communication protocol B and including the property of the data model B, and transmits the generated communication frame to the second device 3.

Thus, the relay device 1 enables relaying communication between the devices having different data models from each other.

In addition, when converting the data models that differ from each other, the relay device 1 converts the property received from the source device into the higher-order property common to both of the data models, and then converts the higher-order property into a property corresponding to the destination device. This enables accurate conversion of the data models without being affected by such as differences in the predefined granularity of the properties for both of the data models.

Furthermore, the conversion table is easy to extend because the conversion table only requires simple content in which, for each communication protocol, the properties of the data model corresponding to the communication protocol are associated with their higher-order properties.

### Modified Example 1

In the above embodiment, the relay device 1 converts between two types of communication protocols (the communication protocols A and B) and data models (the data models A and B). However, conversion between three or more types of communication protocols (communication protocols A to C) and data models (data models A to C) can also be achieved using the same method as in the above embodiment.

### Modified Example 2

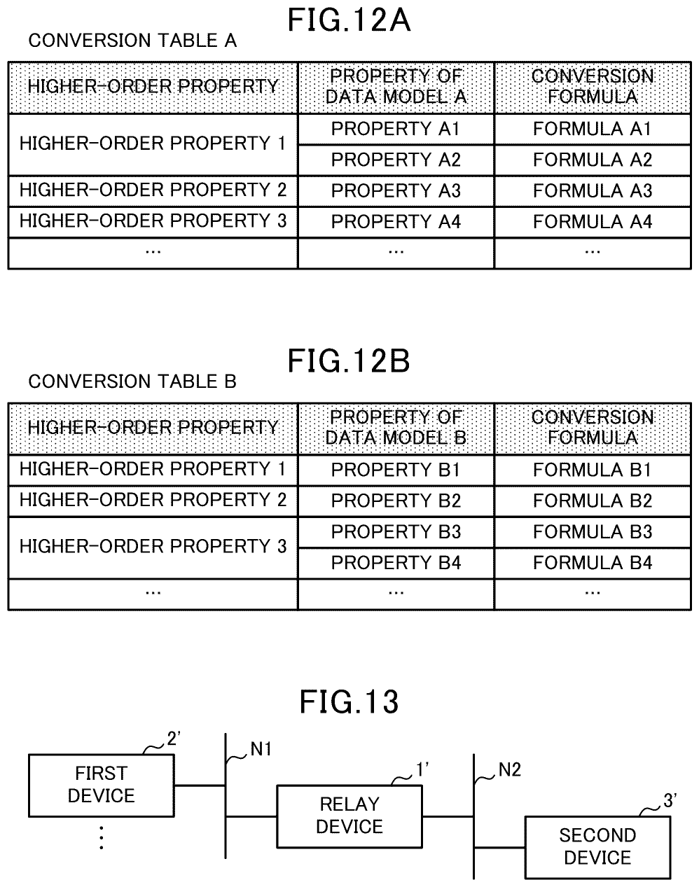

In a case where the property includes a value, the conversion table may further include association with a conversion formula for mutually converting a value of the property and a value of its higher-order property (see FIGS. 12A and 12B). For example, in a case where the relay device 1 receives a communication frame including the property A1 from the first device 2, the data model converter 102 of the relay device 1 refers to FIG. 12A and converts the property A1 into its higher-order property 1, and calculates a value of the higher-order property 1 based on the value of the property A1 and the formula A1. Then, the data model converter 102 refers to FIG. 12B and converts the higher-order property 1 into the property B1, and calculates a value of the property B1 based on the value of the higher-order property 1 and the formula B1.

The conversion table of the above modified example may include association with a pointer to a lookup table for value conversion instead of a conversion formula.

### Modified Example 3

In the above embodiment, the property information is assumed to include information on a property not supported by the device, but the property information may also include information on a property supported by the device, or may include both types of information.

### Modified Example 4

The device information obtainer 100 may obtain the property information from the connected device after the negotiation is completed, rather than during the capability exchange in the negotiation with the connected device.

### Modified Example 5

All or part of the functional components of the relay device 1 (see FIG. 5) may be achieved by dedicated hardware. The dedicated hardware is, for example, a single circuit, a composite circuit, a programmed processor, an application specific integrated circuit (ASIC), a field-programmable gate array (FPGA), or a combination thereof.

The technical concepts for the above modified examples may be achieved independently or in combination as appropriate.

### Embodiment 2

The following is a description of Embodiment 2 of the present disclosure. In the following description, components that are common to those of Embodiment 1 are given the same reference signs, and the descriptions thereof are omitted.

FIG. 13 illustrates an overall configuration of a network system including a relay device 1′ in Embodiment 2. In this network system, one or more first devices 2′ and the relay device 1′ are connected to a network N1, and the relay device 1′ and a second device 3′ are connected to a network N2. This network system is used, for example, as a system for controlling home appliances in a house.

### Relay Device 1′

The relay device 1′ is an example of a relay device according to the present disclosure and relays communication between devices that perform communication using different communication protocols from each other. The hardware configuration of the relay device 1′ is the same as that of the relay device 1 of Embodiment 1 (see FIG. 2). Details of functions of the relay device 1′ are described below.

### First Device 2′

The first device 2′ is an example of a first device according to the present disclosure. The first device 2′ is a device that performs communication using a communication protocol A. Examples of the first device 2′ include an air-conditioning device, a lighting device, and various types of sensors. The hardware configuration of the first device 2′ is the same as that of the first device 2 of Embodiment 1 (see FIG. 3). The first device 2′ prestores in the auxiliary storage device 22 a conversion table (i.e., the conversion table A) corresponding to a communication protocol (i.e., the communication protocol A) of the first device 2′, and in response to request from the relay device 1′, the first device 2′ transmits to the relay device 1′ the conversion table stored in the auxiliary storage device 22.

### Second Device 3′

The second device 3′ is an example of a second device according to the present disclosure. The second device 3′ is a device that performs communication using a communication protocol B, and is, for example, a controller that performs centralized control over each first device 2′. The hardware configuration of the second device 3′ is similar to that of the second device 3 of Embodiment 1 (see FIG. 4). The second device 3′ prestores in the auxiliary storage device 32 a conversion table (i.e., the conversion table B) corresponding to a communication protocol (i.e., the communication protocol B) of the second device 3′, and in response to request from the relay device 1′, the second device 3′ transmits to the relay device 1′ the conversion table stored in the auxiliary storage 32.

### Functional Configuration of Relay Device 1′

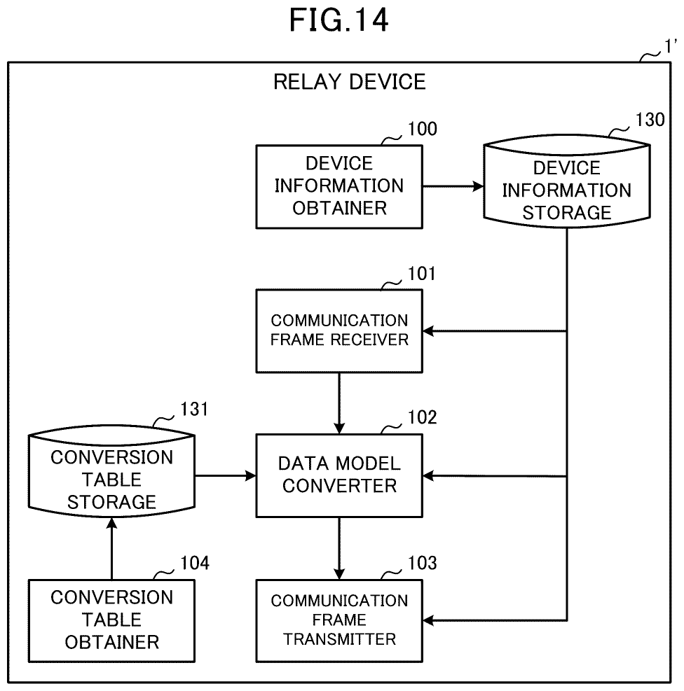

FIG. 14 is a block diagram illustrating a functional configuration of the relay device 1′. As illustrated in FIG. 14, the relay device 1′ includes a device information obtainer 100, a communication frame receiver 101, a data model converter 102, a communication frame transmitter 103, and a conversion table obtainer 104. These functional components are achieved by a control circuit 10 of the relay device 1′ executing a relay program stored in the auxiliary storage device 13, the relay program being for relaying communication frames received and sent between the first device 2′ and the second device 3′.

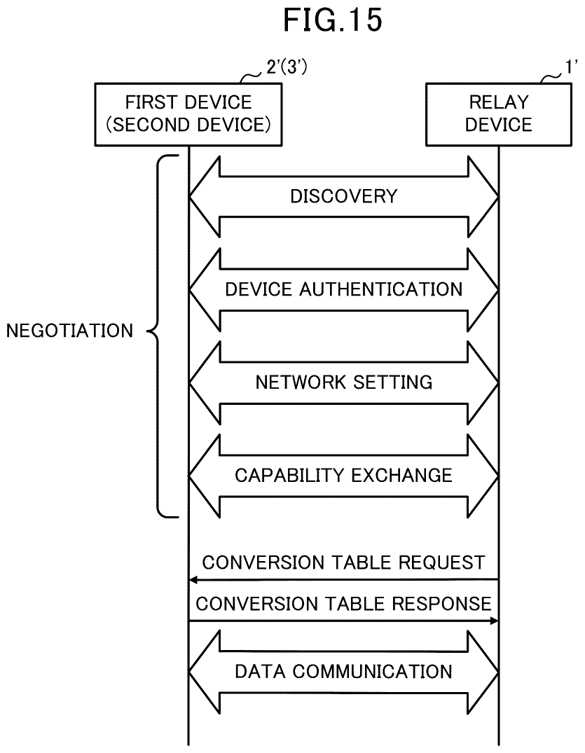

The functional configuration of the above relay device 1′ differs from that of the relay device 1 of Embodiment 1 (see FIG. 5) in that the relay device 1′ further includes a conversion table obtainer 104. The conversion table obtainer 104 is an example of conversion table obtainment means according to the present disclosure. The conversion table obtainer 104 obtains from the connected device (the first device 2′ and the second device 3′) the conversion table held by the device. Specifically, as illustrated in FIG. 15, upon completion of the negotiation at the initial connection with the device, the conversion table obtainer 104 transmits to the device a message (hereinafter referred to as a “conversion table request message”) requesting the conversion table.

The device that receives the conversion table request message transmits to the relay device 1′ a response message (hereinafter referred to as a “conversion table response message”) including the conversion table held by the device. Upon receiving the conversion table response message, the relay device 1′ retrieves and obtains the conversion table from the conversion table response message. The conversion table obtainer 104 saves the obtained conversion table in the conversion table storage 131.

### Conversion Table Obtainment Processing

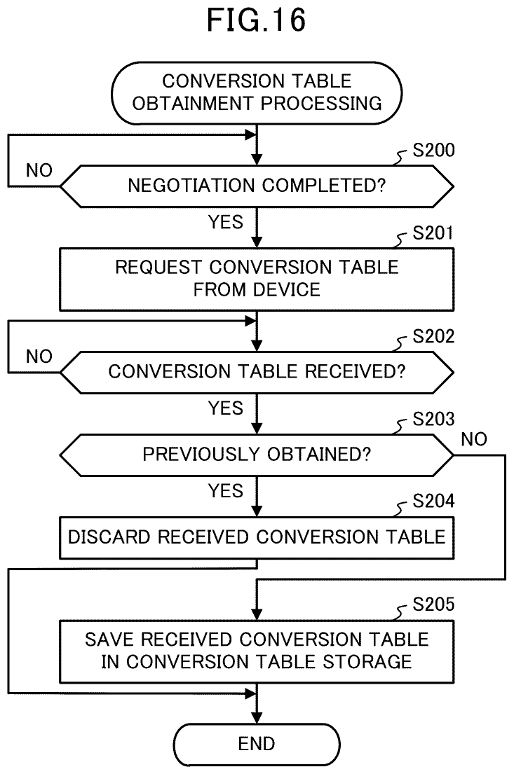

FIG. 16 is a flowchart illustrating a procedure for conversion table obtainment processing executed by the relay device 1′. The conversion table obtainment process is executed at the time of initial connection with each device.

### Step S200

The relay device 1′ determines whether or not negotiation is complete with the initially connected device. When the negotiation is not complete (No in step S200), the relay device 1′ continues to perform the determination in step S200. When the negotiation is complete (Yes in step S200), the processing by the relay device 1′ moves to step S201.

### Step S201

The relay device 1′ requests the conversion table from the device. Then, the processing by the relay device 1′ moves to step S202.

### Step S202

The relay device 1′ determines whether or not the relay device 1′ receives the conversion table. When the conversion table is not received (No in step S202), the relay device 1′ continues to perform the determination in step S202. When the conversion table is received (Yes in step S202), the processing by the relay device 1′ moves to step S203.

### Step S203

The relay device 1′ determines whether or not the received conversion table is the same as the previously-obtained conversion table. When the received conversion table is the same as the previously-obtained conversion table (Yes in step S203), the processing by the relay device 1′ moves to step S204. When the received conversion table is not the same as the previously-obtained conversion table (No in step S203), the processing by the relay device 1′ moves to step S205.

### Step S204

The relay device 1′ discards the received conversion table and ends the conversion table obtainment processing for the device.

### Step S205

The relay device 1′ saves the received conversion table in the conversion table storage 131 with a file name associated with the communication protocol of the device. For example, in a case where the communication protocol of the device is the communication protocol A, the relay device 1′ saves the conversion table in the conversion table storage 131 as the conversion table A. Then, the relay device 1′ ends the conversion table obtainment processing for the device.

The relay processing executed by relay device 1′ is the same as that executed by the relay device 1 in Embodiment 1 (see FIGS. 10 and 11).

As described above, in a case where the relay device 1′ of the present embodiment receives, for example, from the first device 2′ that performs communication using the communication protocol A, a communication frame addressed to the second device 3′ that performs communication using the communication protocol B, the relay device 1′ refers to the conversion table A corresponding to the communication protocol A and converts the property included in the communication frame into its higher-order property, and refers to the conversion table B corresponding to the communication protocol B and converts the higher-order property into a property of the data model B. Then, the relay device 1′ generates a communication frame conforming to the communication protocol B and including the property of the data model B, and transmits the generated communication frame to the second device 3′.

Thus, the relay device 1′ enables relaying communication between the devices having different data models from each other.

In addition, when converting the data models that differ from each other, the relay device 1′ converts the property received from the source device into the higher-order property common to both of the data models, and then converts the higher-order property into a property corresponding to the destination device. This enables accurate conversion of the data models without being affected by such as differences in the predefined granularity of the properties for both of the data models.

Furthermore, the conversion table is easy to extend because the conversion table only requires simple content in which, for each communication protocol, the properties of the data model corresponding to the communication protocol are associated with their higher-order properties.

Also, the relay device 1′ obtains the conversion table from the connected device. Thus, there is no need to preset the conversion table in the relay device 1′, and also, easier support for devices that use new communication protocols and improved versatility can be achieved.

### Modified Example 1

The conversion table obtainer 104 of the relay device 1′ may, rather than obtaining the conversion table from the connected device, alternatively obtain such through communication with a server, such as a cloud server, via the network N1, the network N2, or other networks. In this case, the conversion table obtainer 104 specifies the communication protocol of the connected device, a device identification (ID) of the connected device, a model of the connected device, a model number of the connected device, or the like, and then obtains from the server the conversion table corresponding to the communication protocol.

### Modified Example 2

The device information obtainer 100 may obtain the property information from the connected device after the negotiation is completed, rather than during the capability exchange in negotiation with the connected device. In that case, the device information obtainer 100 may obtain the property information from the device after the conversion table is obtained by the conversion table obtainer 104 from the device.

### Modified Example 3

All or part of the functional components of the relay device 1′ (see FIG. 14) may be achieved by dedicated hardware. The dedicated hardware is, for example, a single circuit, a composite circuit, a programmed processor, an ASIC, an FPGA, or a combination thereof.

### Modified Example 4

The modified examples 1 to 3 of Embodiment 1 may also be applied in the present embodiment.

The foregoing describes some example embodiments for explanatory purposes. Although the foregoing discussion has presented specific embodiments, persons skilled in the art will recognize that changes may be made in form and detail without departing from the broader spirit and scope of the invention. Accordingly, the specification and drawings are to be regarded in an illustrative rather than a restrictive sense. This detailed description, therefore, is not to be taken in a limiting sense, and the scope of the invention is defined only by the included claims, along with the full range of equivalents to which such claims are entitled.

### INDUSTRIAL APPLICABILITY

The present disclosure can be preferably employed in a system that performs communication between devices having different communication protocols from each other.

### REFERENCE SIGNS LIST

1, 1′ Relay device
2,2′ First device
3, 3′ Second device
10, 20, 30 Control circuit
11 First communication interface
12 Second communication interface
13, 22, 32 Auxiliary storage device
21, 31 Communication interface
100 Device information obtainer
101 Communication frame receiver
102 Data model converter
103 Communication frame transmitter
104 Conversion table obtainer
130 Device information storage
131 Conversion table storage
N1, N2 Network

1. A relay device, comprising:
a first communication interface to communicate with a first device whose communication protocol is a first protocol;
a second communication interface to communicate with a second device whose communication protocol is a second protocol that is different from the first protocol;
a conversion table storage to store a first conversion table for a first data model corresponding to the first protocol and a second conversion table for a second data model corresponding to the second protocol, the first conversion table being a table in which a property of the first data model is associated with a higher-order property of the property of the first data model, the second conversion table being a table in which a property of the second data model is associated with a higher-order property of the property of the second data model; and
circuitry to
when a communication frame from the first device is received, convert a property included in the communication frame into a higher-order property with reference to the first conversion table, and convert the higher-order property into a property of the second data model with reference to the second conversion table, and
when a communication frame from the second device is received, convert a property included in the communication frame into a higher-order property with reference to the second conversion table, and convert the higher property into a property of the first data model with reference to the first conversion table; and
generate a communication frame conforming to the second protocol and including the property of the second data model, and transmit the generated communication frame to the second device, and
generate a communication frame conforming to the first protocol and including the property of the first data model, and transmit the generated communication frame to the first device.

2. The relay device according to claim 1, wherein:
the circuitry obtains the first conversion table from the first device, saves the obtained first conversion table in the conversion table storage, obtains the second conversion table from the second device, and saves the obtained second conversion table in the conversion table storage.

3. A relay method, comprising:
by a computer including
a first communication interface to communicate with a first device whose communication protocol is a first protocol,
a second communication interface to communicate with a second device whose communication protocol is a second protocol that is different from the first protocol, and
a conversion table storage to store a first conversion table for a first data model corresponding to the first protocol and a second conversion table for a second data model corresponding to the second protocol, the first conversion table being a table in which a property of the first data model is associated with a higher-order property of the property of the first data model, the second conversion table being a table in which a property of the second data model is associated with a higher-order property of the property of the second data model,
when a communication frame from the first device is received, converting a property included in the communication frame into a higher-order property with reference to the first conversion table, and converting the higher-order property into a property of the second data model with reference to the second conversion table;
generating a communication frame conforming to the second protocol and including the property of the second data model, and transmitting the generated communication frame to the second device;
when a communication frame from the second device is received, converting a property included in the communication frame into a higher-order property with reference to the second conversion table, and converting the higher-order property into a property of the first data model with reference to the first conversion table; and
generating a communication frame conforming to the first protocol and including the property of the first data model, and transmitting the generated communication frame to the first device.

4. A non-transitory computer-readable recording medium storing program, the program causing a computer including
a first communication interface to communicate with a first device whose communication protocol is a first protocol,
a second communication interface to communicate with a second device whose communication protocol is a second protocol that is different from the first protocol, and
a conversion table storage to store a first conversion table for a first data model corresponding to the first protocol and a second conversion table for a second data model corresponding to the second protocol, the first conversion table being a table in which a property of the first data model is associated with a higher-order property of the property of the first data model, the second conversion table being a table in which a property of the second data model is associated with a higher-order property of the property of the second data model,
to function as:
a data model converter to
when a communication frame from the first device is received, convert a property included in the communication frame into a higher-order property with reference to the first conversion table, and convert the higher-order property into a property of the second data model with reference to the second conversion table, and
when a communication frame from the second device is received, convert a property included in the communication frame into a higher-order property with reference to the second conversion table, and convert the higher property into a property of the first data model with reference to the first conversion table; and
a communication frame transmitter to
generate a communication frame conforming to the second protocol and including the property of the second data model obtained by the data model converter, and transmit the generated communication frame to the second device, and
generate a communication frame conforming to the first protocol and including the property of the first data model obtained by the data model converter, and transmit the generated communication frame to the first device.
